(19) United States
(12) Patent Application Publication
(10) Pub. No.: US 2008/0034284 A1
(43) Pub. Date: Feb. 7, 2008

(54) METHOD AND SYSTEM FOR DISPLAYING MULTIMEDIA CONTENT

(75) Inventors: Jason Skicewicz, Honolulu, HI (US); Lorenz Sell, Honolulu, HI (US); Earle Ady, Alexandria, VA (US); Nesan Waran, Honolulu, HI (US); Derrick Petzold, Honolulu, HI (US)

Correspondence Address: STRATEGIC PATENT GROUP, P.C., P.O. BOX 1329, MOUNTAIN VIEW, CA, 94042, US

(73) Assignee: BLUE LAVA TECHNOLOGIES, Honolulu, HI (US)

(21) Appl. No.: 11/828,765

(22) Filed: Jul. 26, 2007

Related U.S. Application Data
(60) Provisional application No. 60/833,882, filed on Jul. 28, 2006.

(51) Int. Cl. G06F 3/14

(52) U.S. Cl. 715/246; 715/243

(57) ABSTRACT

A computer-implemented method and system for displaying items of multimedia content are described. In one aspect, the method and system include determining attribute(s) associated with each item and determining a size and/or a location of each of a first portion of the items based on the attribute(s). The size and location of one item is different from the size and location of another item. The method and system also include displaying at least a second portion of the items together in a planar distribution in which each item has the size and location determined using the attributes. In another aspect, the method and system include determining an ambient color of an item. The item has a plurality of colors on which the ambient color is based. In this aspect, the method and system also include determining a frame including the ambient color and displaying the item in the frame.

### CROSS-REFERENCE TO RELATED APPLICATION

The present application claims priority from to co-pending provisional application Ser. No. 60/833,882, filed Jul. 28, 2006, entitled “Method and System for Managing and Maintaining Content”, assigned to the assignee of the present application.

### BACKGROUND OF THE INVENTION

Managing content, including but not limited to multimedia content such as video and image data, continues to be a challenge. For example, an enormous number of digital photos (photos) are taken by individuals each year. The majority of such photos sit dormant on users' computers without being organized, shared or displayed.

In a conventional system, multimedia content may be displayed to users. Typically, the multimedia content, such as images, is arranged in an array. For example, images such as photos in digital format, may be displayed in a strip near the bottom of a user's display. Typically, such conventional systems display thumbnails, or smaller and lower resolution versions of the image, in the strip. A selected one of the thumbnails may be displayed above the strip.

Although users can view images in the strip, one of ordinary skill in the art will recognize that there are drawbacks. In particular, it may be desirable to draw the user's attention to the images or depict more images on the screen at the same time. Accordingly, what is needed is an improved method and system for displaying multimedia content.

### BRIEF SUMMARY OF THE INVENTION

A computer-implemented method and system for displaying multimedia content are described. The multimedia content includes a plurality of items. In one aspect, the method and system include determining attribute(s) associated with each of the items and determining a size and/or a location of each of a first portion of the items based on the attribute(s). The size and location of one of the items is different from the size and location of another of the plurality of items. In this aspect, the method and system also include displaying a second portion of the items together in a planar distribution. Each of the items is displayed in the location and has the size determined using the attribute(s). In another aspect, the method and system include determining an ambient color of an item of the plurality of items. The item has a plurality of colors on which the ambient color is based. In this aspect, the method and system also include determining a frame including the ambient color and displaying the item in the frame.

According to the method and system disclosed herein, the present invention provides a mechanism for improving the display of multimedia content to a user.

### BRIEF DESCRIPTION OF SEVERAL VIEWS OF THE DRAWINGS

FIG. 1 is a diagram of an exemplary embodiment of a computer system used in organizing and viewing multimedia content.

FIG. 2 is an exemplary embodiment of a system for displaying multimedia content.

FIG. 3 is an exemplary embodiment of a method for displaying multimedia content in a cloud.

FIG. 4 is an exemplary embodiment of a method for displaying multimedia content in a cloud.

FIG. 5 depicts an exemplary embodiment of multimedia content.

FIG. 6 is a diagram of an exemplary embodiment of a method for displaying content having a frame.

FIG. 7 is a diagram of another exemplary embodiment of a method for displaying content having a frame.

FIG. 8 is a diagram of another exemplary embodiment of a method for displaying content having a frame.

FIG. 9 depicts an exemplary embodiment of multimedia content when framed.

### DETAILED DESCRIPTION OF THE INVENTION

The present invention relates to display of multimedia content. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A computer-implemented method and system for displaying multimedia content are described. The multimedia content includes a plurality of items. In one aspect, the method and system include determining attribute(s) associated with each of the items and determining a size and/or a location of each of a first portion of the items based on the attribute(s). The size and location of one of the items is different from the size and location of another of the plurality of items. In this aspect, the method and system also include displaying a second portion of the items together in a planar distribution. Each of the items is displayed in the location and has the size determined using the attribute(s). In another aspect, the method and system include determining an ambient color of an item of the plurality of items. The item has a plurality of colors on which the ambient color is based. In this aspect, the method and system also include determining a frame having the ambient color and displaying the item in the frame.

The method and system are mainly described in terms of particular systems provided in particular implementations. However, one of ordinary skill in the art will readily recognize that this method and system will operate effectively in other implementations. For example, portions of the method and system may be described in the context of a desktop system and/or a remote system, which may be accessed through a network such as the Internet. However, one of ordinary skill in the art will recognize that the method and system may be utilized in other systems. For example, portions described in the context of a desktop system might be used in a network such as the Internet, or vice versa. Thus, the systems, devices, and networks usable with the method and system can take a number of different forms. The method will also be described in the context of certain steps. However, the method and system operate effectively for other methods having different and/or additional steps not inconsistent with the present invention. Further, the steps in the method may be performed in a different order, including in parallel. In addition, although the method and system may be described with respect to single items, one of ordinary skill in the art will recognize that the method and system also operate effectively for multiple items. In addition, the method and system are described in the context of multimedia items, such as images. As used herein, an item of multimedia content includes at least one image. In some embodiments, multiple images, for example a video clip, sound, and/or other content may also be part of the item. One of ordinary skill in the art will recognize that images include photos. A photo may include a full resolution version of the image, or a smaller, lower resolution of the photo typically known as a thumbnail. One of ordinary skill in the art will also recognize that although multimedia content includes images, the method and system may be used for other multimedia content, such as video clips.

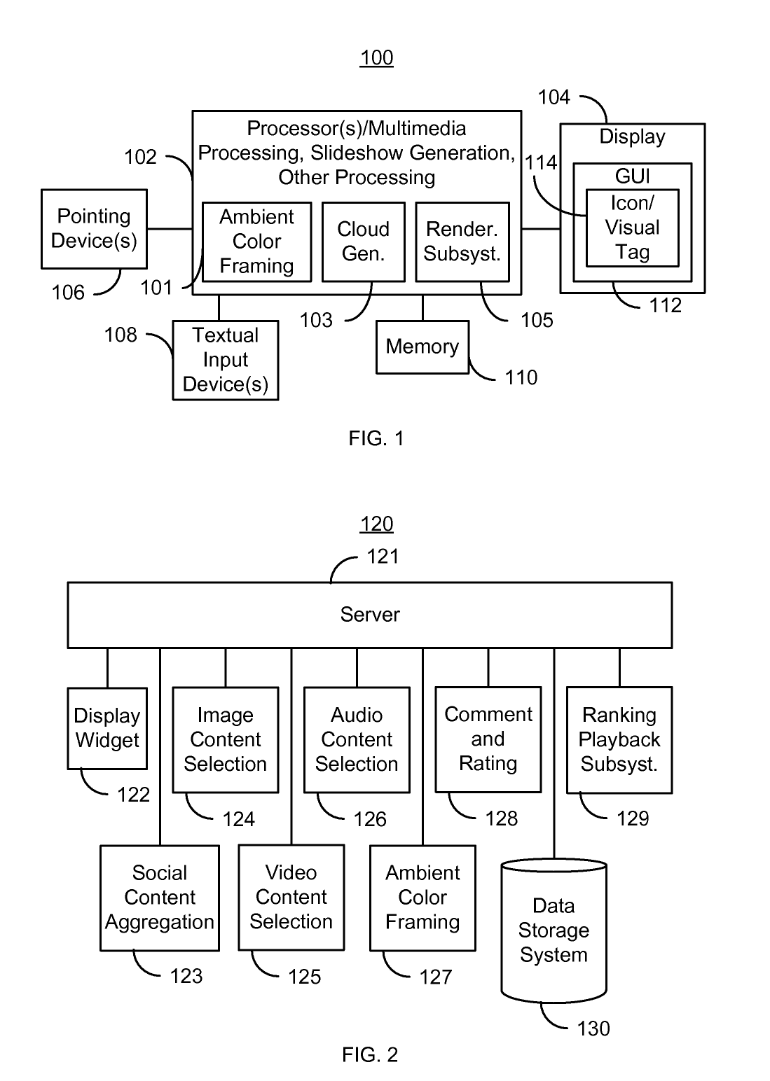

FIG. 1 is a simplified diagram of an exemplary embodiment of a computer system 100 used in organizing and displaying multimedia content. The computer system 100 includes processing block 102, pointing device(s) 106, textual input device(s) 108, memory 1 10, and display 104. The computer system 100 may include additional components (not shown) and is used in providing the graphical user interface (GUI) 112 on which images or other multimedia content may be displayed. In one embodiment, the computer system 100 is entirely on a user's computer, or desktop system. However, in an alternate embodiment, one or more components of the system 100 may reside elsewhere and be remotely accessed.

The processing block 102 may include multiple hardware components and software modules. For example, ambient color framing subsystem 101 and cloud generation subsystem 103 may be used to select items of multimedia content, frame the items, and/or determine the size and arrangement of the items, respectively. Rendering subsystem 105 may be used in rendering the items of multimedia content. In addition to other functions described herein, the processing block 102 performs processing utilized in slideshow generation, organization of photos, event detection, merging of photos sets, social organization, and gaming feedback for use in connection with the organization of photos and other related activities. The processing block 102 may reside entirely on the user's computer system or may reside in whole or in part upon a server or other computer system remote from the user's computer. The pointing device(s) 106 may include devices such as a mouse or scratch pad and are represented visually on the GUI 112 by a pointer (not shown in FIG. 1). The pointer may take on a variety of incarnations including but not limited to an arrow or other graphic which may provide gaming feedback such as changing appearance based upon the user's actions. The memory 110 may include local memory as well as long term storage. In addition, the memory 110 may include portions directed to storage of specific items of multimedia, such as archiving of images and/or their attributes or other metadata.

Through the system 100 and the GUI 112, users may be allowed view and organize multimedia content. In one embodiment, the GUI 112 may use visual tags 114. Visual tags 114 include a graphical representation of information related to multimedia content, such as photos. Thus, visual tags 114 are described herein in the context of images. For example, visual tags 114 may represent a photo, a portion of a photo, individuals within photos, events related to photos, locations related to photos, and/or multiple photos. The graphical representations of the visual tags 114 are icons. The icon may be a portion of one of the photo(s) corresponding to the visual tags 114, but may be another graphic. Thus, the visual tags 114 include graphical information for the icon. The visual tags 114 may also include other information. In one embodiment, the visual tags 114 also include traditional metadata such as textual data, a date stamp, a time stamp, other timing information such as a time range, hashing information, and error detection information, or other attributes of the photo. In one embodiment, the hashing information may indicate whether two images and/or two visual tags 114 are duplicates. For example, if two images or two visual tags 114 hash to the same value, it is very likely that the images/visual tags are the same. Furthermore, the visual tags 114 may include additional metadata such as a visual tag group indicating a group of photos to which the visual tags 114 correspond, the visual tag owners who created the tags and voting information indicating a popularity of photos corresponding to the visual tags 114. The visual tags 114 may also include slideshow information used in determining whether and how to include the photos corresponding to the visual tags 114 in a slideshow. The slideshow information may be obtained using the method and system described herein. For example, an indication of whether to upgrade, downgrade, or exclude a corresponding photo from a slideshow may be included in the visual tags 114. Upgrading a particular photo may make the photo more likely to be included in a slideshow, indicate that the photo is to be displayed for a longer time in the slideshow, and/or indicate that the photo is to be placed earlier in the slideshow. The slideshow information may be based upon the voting information or other information described herein. The visual tags 114 may also include address information for individuals (if any) corresponding to the visual tags 114. The visual tags 114 may also include event information, such as the time duration of the event, who participated, where the event took place, for events associated with the visual tags 114. Thus, visual tags 114 may include a variety of information, including icons for display, textual data, and other metadata. This information may thus be used in organizing and displaying photos.

FIG. 2 depicts another exemplary embodiment of a system 120 for managing and displaying data, particularly multimedia data. At least portions of the system 120 may be used in conjunction with or in lieu of at least portions of the system 100. The system 120 may include one or more of a server 121 utilizing a display widget 122, social content aggregation subsystem 123, image content selection subsystem 124, video content selection subsystem 125, audio content subsystem 126, ambient color framing subsystem 127, comment and rating subsystem 128, and ranking playback subsystem 129, as well as a data storage system 130 that may be a database. The data storage system 120 may include containers (not shown). Thus, the system 120 may be used to archive and display content such as audio, video, and digital images. The content archived in the data storage system 120 may be managed using the components 122, 123, 124, 125, 126, 127, 128, and 129. Although depicted as separate components, the display widget 122, social content aggregation subsystem 123, image content selection subsystem 124, video content selection subsystem 125, audio content subsystem 126, ambient color framing subsystem 127, comment and rating subsystem 128, and ranking playback subsystem 129 may interact and/or may be combined in other modules (not shown). For example, the social content aggregation subsystem 123 might utilize the display widget 122 for purposes such as providing output. Moreover, input may be accepted from pages (not shown) including the display widget 122 without leaving the web page. In addition, although the display widget 122, social content aggregation subsystem 123, image content selection subsystem 124, video content selection subsystem 125, audio content subsystem 126, ambient color framing subsystem 127, comment and rating subsystem 128, and ranking playback subsystem 129 are depicted, other embodiments of the system 100 may contain a subset of the components 122, 123, 124, 125, 126, 127, 128, and 129 and/or may include additional components and functionality (not shown). In addition, one of ordinary skill in the art will readily recognize that other embodiments not inconsistent with the method and system 120 may be utilized.

The system 120 may be used to store and manage content, such as images (e.g. photographs) and video, as well as audio. The content which may be accessed via a web page (not shown). Such content may be provided to the system 120 via display widget 122 on the page or through another source including but not limited to other computer systems, email, and cell phones. The system 120 may archive and selectively present the content to user(s) via the web page. In presenting the content to the users, the system 120 utilizes components 122, 123, 124, 125, 126, 127, 128, and 129. Thus, in addition to allowing content to be uploaded by a user (through the display widget 122 without leaving the page or other means), certain other users may also upload content (through the display widget 122 without leaving the page or other means). Thus, the system 120 allows a community to aggregate the content. Furthermore, the system 120 allows a community of users to evaluate the content, for example through a hosted page. In one embodiment, individual items of content as well as collections of the content may be ranked. As a result, a channel of content may be created through the system 100 to accommodate special interests of communities. The system 100 also allows subsets of content to be automatically selected and presented to users based on specific criteria. For example, video clips or images may be selected based upon the criteria and presented to the user in the form of a video or slide show. The users may then comment on and rank the content. Moreover, the system 100 may present items to the user in a more desirable manner, for example by selecting an ambient background color based on the images or video and/or sizing the content based upon the community's evaluation of the content. The functions of the system 100 are described below.

Using the system 120 multimedia content such as images, and/or video, as well as audio may be managed. In one aspect, the system 120 utilizes the embeddable display widget 122 for playing multimedia content and which allows for updating of multimedia content by viewers of the widget's contents without leaving the page on which the widget is viewed. In another aspect, the method and system include using a distributed human computing engine to aggregate, comment on, rank, and/or otherwise organize the content. Thus, social content aggregation 123, comment and rating subsystem 128 may be used to organize content based on the distributed human computing engine. Stated differently, communities are allowed to comment on and rate multimedia content as well as audio. The system 120 may then organize the multimedia content and play back the multimedia content based upon the comments and rating of users in the communities. In order to do so, image content selection 124, video content selection 215, audio content selection 126, and ranking playback subsystem may be used in conjunction with comment and rating 128 and social content aggregation 123. Furthermore, the distributed human computing engine may interact with the content at least in part through the embeddable widget 122. The system 120 may also automatically organize the content based on specific criteria, such as the comments and ranking. The system 120 may also present subsets of the content to the users, for example in a slideshow, set of video clips, and/or audio selections. These tasks may be accomplished using image content selection 124, video content selection 215, audio content selection 126, and ranking playback subsystem. The system 120 may also control the manner in which content is played, for example through ambient color framing described herein and/or playback of multimedia content based upon ranking. Thus, content may be managed and maintained.

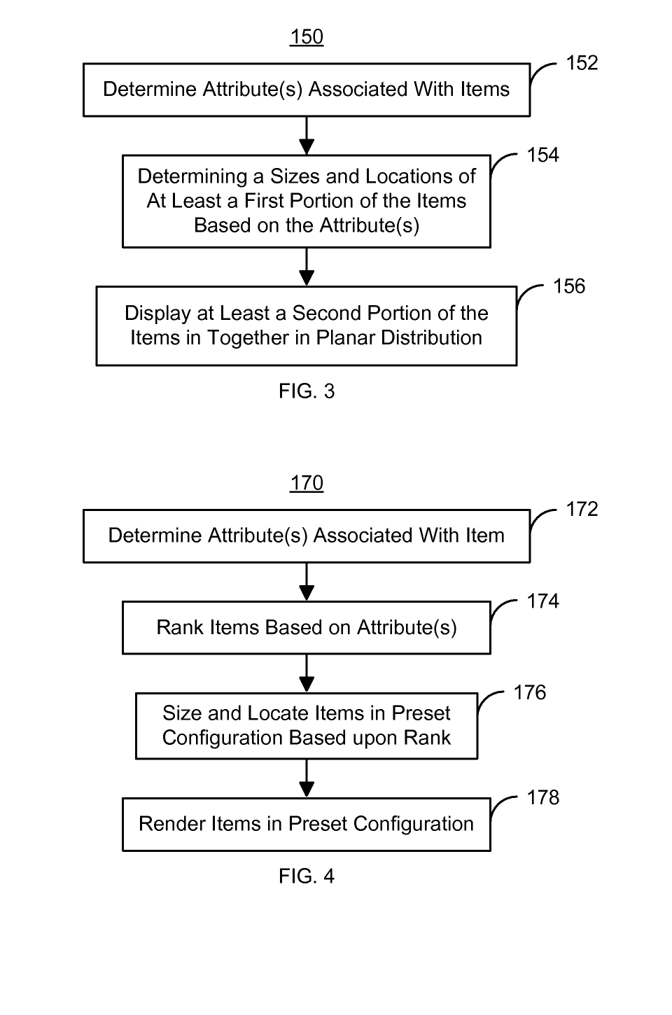

FIG. 3 is a diagram of an exemplary embodiment of a method 150 for displaying items multimedia content in a cloud. The method 150 may be performed in conjunction with the system 100 and/or 120. However, for clarity, the method 150 is described in the context of the system 100. The method 150 is used for items of multimedia content. These items include at least one image. For example, the items might include images such as photos and/or video clips. In one embodiment, the items are part of a set, such as a group of photos uploaded to the system 100 and/or other multimedia items stored in a single container or folder.

One or more attributes associated with each of the items is determined, via step 152. In one embodiment, the attribute(s) correspond to a popularity of the item. The popularity of the item might be measured in a number of ways. For example, the number of times the item has been shared, the number of positive comments from individuals viewing the item, the amount of time the user has viewed the item, the number of times the user has viewed the item may be attributes corresponding to the item's popularity. Other attributes such as the distance to individual(s) depicted in the items and/or preferences set by the user may also be determined in step 152. For example, if the user specifies a particular image as the favorite, this attribute may be determined in step 152. In one embodiment, the attribute may include a setting for a specific size or location, for example in return for payment. Step 152 may be performed using the cloud generation subsystem 103. In one embodiment, step 152 includes accessing information already provided for the items, for example by reading data corresponding to the visual tags 114 of the items. In another embodiment, the user might optionally be requested to enter preferences or other information.

The size and location at which each item is to be displayed is determined for at least a first portion of the items, via step 154. In step 154, sizes and locations may be determined for some subset of or all of the items for which attribute(s) were determined in step 152. For example, the attribute(s) determined in step 152 may indicate a ranking of the items. In one embodiment, only items having a sufficiently high ranking may be displayed. Less popular items may not be displayed at all. In such an embodiment, step 154 may determine the size and location only for those items that are to be displayed. Thus, in one embodiment, the sizes and locations are only determined for those some of the items. In an alternate embodiment and/or if there are fewer items, the sizes and locations may be determined for all of the items in step 154. In addition, the size and/or the location on the screen for each item are determined based on the attribute(s). In one embodiment, items which have a higher ranking may have a larger size. Similarly, items having a higher ranking may have a particular position, such as a more central position. For example, items more positive comments or which are shared more may have a larger size and/or may be assigned a more central location in the display. Thus, the size and location of one item may be different from the size and location of another of the items. In one embodiment, a particular number of sizes may be available. In such an embodiment, the highest ranked item(s) may have the largest size, the next highest ranked item(s) may have the next largest size, and so on. For example, if nine items are to be distributed among three sizes (one large, two medium, and six small), the most popular item may have the largest size, the next two most popular items may have the medium size, and the remaining items may have the small size. In an alternate embodiment, the sizes and locations may not be so limited.

At least a second portion of the items are displayed together in a planar distribution on the display 104, via step 156. In one embodiment, step 156 may be performed by the rendering subsystem 105. Note that step 156 may display only a portion of the items available. For example, only a certain number of the most popular items might be displayed in step 156. Each of the items has the size and location determined in step 154. Thus, each of the items is displayed in the location and has the size determined using the attribute(s). Because the distribution is planar, the items are not arranged in a linear fashion. Thus, the items would not be arranged in a simple strip along the bottom of the display. The shape of the planar distribution may be irregular because of the varying sizes and locations of the items. Consequently, the planar distribution is termed herein a cloud. In addition to altering the size, the resolution of the items may be changed. For example, because the items may not be shown at their full size, the item(s) may also be rendered at a lower resolution. Thus, if the items are images, thumbnails or other resolution versions may be displayed in step 156. Similarly, if the items are visual tags, then the icons corresponding to the visual tags may be displayed in varying size and resolution in step 156. In one embodiment, the items are displayed in a contiguous arrangement. Stated differently, the items may be displayed such that the edges of the items are in contact.

Consequently, using the method 150, items may be displayed in varying sizes across the display 104. Thus, the user's attention may be drawn to particular items, as well as to the existence of the items in general. A user's ability to access and view their multimedia content may thus be improved.

FIG. 4 depicts is a diagram of an exemplary embodiment of a method 170 for displaying items multimedia content in a cloud. The method 170 may be performed in conjunction with the system 100 and/or 120. However, for clarity, the method 170 is described in the context of the system 100. The method 170 is used for items of multimedia content. These items include at least one image. For example, the items might include images such as photos and/or video clips. In one embodiment, the items are part of a set, such as a group of photos uploaded to the system 100 and/or other multimedia items stored in a single container or folder.

One or more attributes associated with each of the items is determined, via step 172. Step 172 thus corresponds to step 152 of the method 150 depicted in FIG. 3. Referring back to FIG. 4, the items are ranked based upon their attributes. For example, the items may be ranked from highest to lowest number of positive comments or votes.

The sizes and locations of at least a portion of the items in a preset configuration may be determined based upon the ranking, via step 176. The preset configuration may be a cloud that is preconfigured to have a particular appearance, including a particular number of items of each of a number of sizes. In addition, the preset configuration might be one of a number of preset configurations. In the preset configuration, therefore, a determination of the size may also limit and/or determine the location. In addition, the preset configuration may also limit the number of items to be displayed. For example, items having the highest rankings may have the largest sizes in the preset configuration. The next highest rankings may have the next largest sizes. This may continue until no items remain or the preset configuration is filled with items. Thus, steps 174 and 176 may be considered analogous to step 154 of the method 150 depicted in FIG. 3. Steps 174 and 176 may be performed by the cloud generation subsystem 103.

Referring back to FIG. 4, the items are rendered in the preset configuration on the display 104, via step 178. Step 178 may be performed using the rendering subsystem 105. Step 178 is analogous to step 156 of the method 150 depicted in FIG. 3.

Referring back to FIG. 4, the method 170 thus allows items of varying sizes to be displayed based upon their attributes. In addition, the display has the desired look of the preset configuration. Consequently, the user's attention may be drawn to particular items, as well as to the existence of the items in general while maintaining a desired look of the display. A user's ability to access and view their multimedia content may thus be improved.

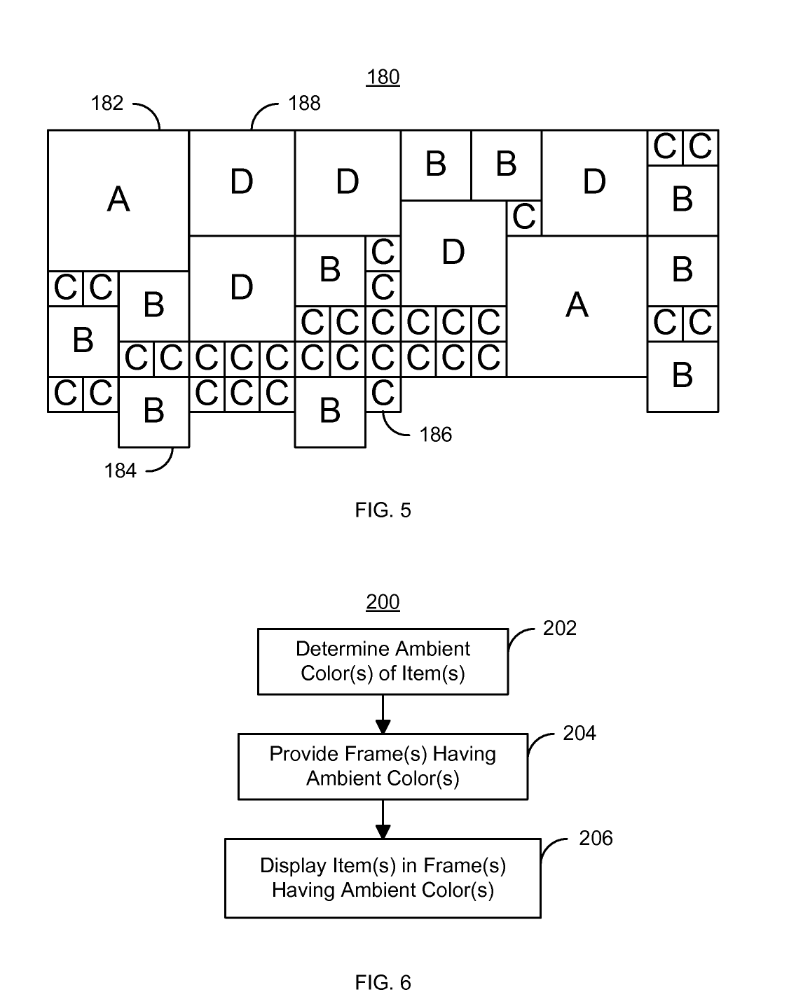

FIG. 5 depicts an exemplary embodiment of multimedia content displayed as a cloud 180 using the method 150 and/or 170. The cloud 180 includes multiple items which are represented by regions A 182, B 184, C 186, and D 188. For clarity, only one of each region A 182, B 184, C 186, and D 188 is numerically denoted. In the cloud 180 shown, therefore, there are four possible sizes. For the cloud 180, the regions A 182, B 184, C 186, and D 188 are contiguous. Stated differently, each region A 182, B 184, C 186, and D 188 share boundaries with other regions A 182, B 184, C 186, and D 188. In addition, there are no empty spaces within the cloud 180. However, in another embodiment, spaces could exist within the cloud 180. Thus, although a specific configuration of the cloud 180 is shown, another configuration including other sizes might be used. In one embodiment, each item in regions 182, 184, 186, and 188 is a thumbnail, or reduced resolution and reduced size version of an image such as a photo. However, in another embodiment, other items of multimedia content could be used.

Thus, using the method 150 and/or 170 and the cloud 180 items may be displayed in an interesting configuration. Particular attention may be drawn to items, such as those in regions A 182, that have a larger size. In addition, because of the appearance of the cloud 180, the user's attention may be drawn to the items in the cloud 180 in general. Consequently, a user may be better able to view multimedia content.

FIG. 6 is a diagram of an exemplary embodiment of a method 200 for displaying content having a frame. The method 150 may be performed in conjunction with the system 100 and/or 120. However, for clarity, the method 150 is described in the context of the system 100. The method 200 may be used to present items, for example images or video, to the user. The method 200 is thus used for items having a plurality of colors. In one embodiment, the method 200 may be used for black-and-white images. Consequently, as used herein, a plurality of colors may include a plurality of shades.

The ambient color for one or more items being displayed is determined, via step 202. Step 202 may be performed using the ambient color framing subsystem 101. The ambient color is based upon the colors in the item. In one embodiment, the ambient color is an average or mean color. In another embodiment, the ambient color may include adjustments to the average color. For example, the determination of the ambient color may include determining the average color and lightening, darkening, or tinting the average color a particular amount to obtain the ambient color. The average color may be determined in a number of ways, described below. If the item is an image, then the ambient color may be based on an average of the colors in the image. If the item includes video loop, then in one embodiment, the ambient color may be based on an average of the colors of multiple frames of the video. The ambient color for a number of frames of the video, for example all of those in a particular clip of the loop, may be averaged to obtain a single ambient color. The ambient color for video may, therefore, change at transitions between clips. In yet another embodiment the ambient color might be determined for each frame and, therefore, change between frames. However, in another embodiment, a single ambient color might be determined for all video shown in a particular loop.

A frame including the ambient color is determined for each of the items to be displayed in a frame, via step 204. Step 204 may be performed using the ambient color framing subsystem 101. Step 204 may include setting the size of the frame as well as the setting the color of at least part of the frame as the ambient color. In one embodiment, substantially the entire frame has the ambient color. In another embodiment, only a portion of the frame has the ambient color. The items may be displayed in the corresponding frames, via step 206. Step 206 may be performed using the rendering subsystem 105. Because, as discussed above, the ambient color of a video might change, the color of the frame may also change while the item is displayed.

Thus, using the method 200, items may be displayed in frames having colors that correspond to the colors of the item. Consequently, interest may be added to the display of multimedia content.

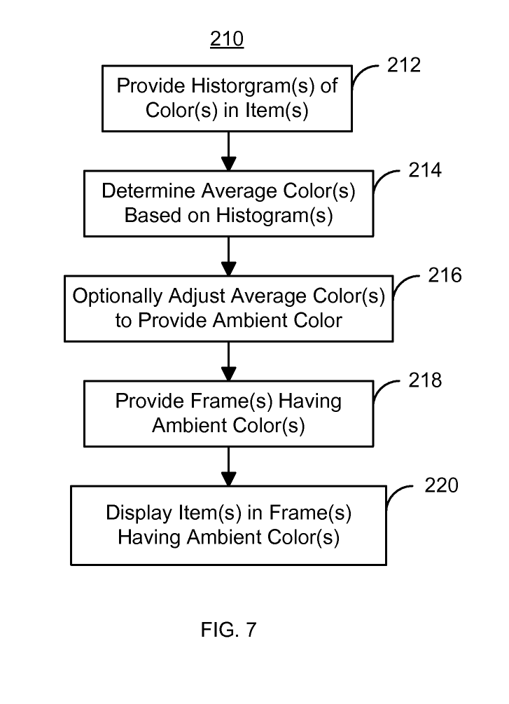

FIG. 7 is a diagram of another exemplary embodiment of a method 210 for displaying content having a frame. The method 210 may be performed in conjunction with the system 100 and/or 120. However, for clarity, the method 210 is described in the context of the system 100. The method 210 may be used to present items, for example images or video, to the user. The method 210 is thus used for items having a plurality of colors, which may include multiple shades. In addition, the method 210 is described in the context of providing tasks relating to multiple items simultaneously. However, one of ordinary skill in the art will recognize that the steps may be performed serially, for example to process items one-by-one.

Histograms of the colors in each item are provided, via step 212. If the item is an image, then the histogram is for the colors in the image. If the item includes video loop, then in one embodiment, the histogram may be for an individual frame. In another embodiment, the histogram may be for a number of frames of the video, for example all of frames in a particular clip of the loop. Average, or mean, colors are determined from the histograms, via step 214. The average color for video may, therefore, change at transitions between clips. In yet another embodiment the average color might be determined for each frame and, therefore, change between frames. However, in another embodiment, a single average color might be determined for all video shown in a particular loop. Note, however, that such a determination of the average colors from histograms might be CPU intensive.

In one embodiment, the ambient color is the average color determined in step 214. However, in another embodiment, the average colors may optionally be adjusted, in step 216. The adjusted average color would then be the ambient color. As discussed above, adjustments made in step 216 might include lightening, darkening, or tinting the average color.

A frame including the ambient color is determined for each of the items to be displayed in a frame, via step 218. Step 218 may be performed using the ambient color framing subsystem 101. Step 218 may include setting the size of the frame as well as the setting the color for at least part of the frame as the ambient color. The items may be displayed in the corresponding frames, via step 220. Step 220 may be performed using the rendering subsystem 105. Because, as discussed above, the ambient color of a video might change, the color of the frame may also change while the item is displayed.

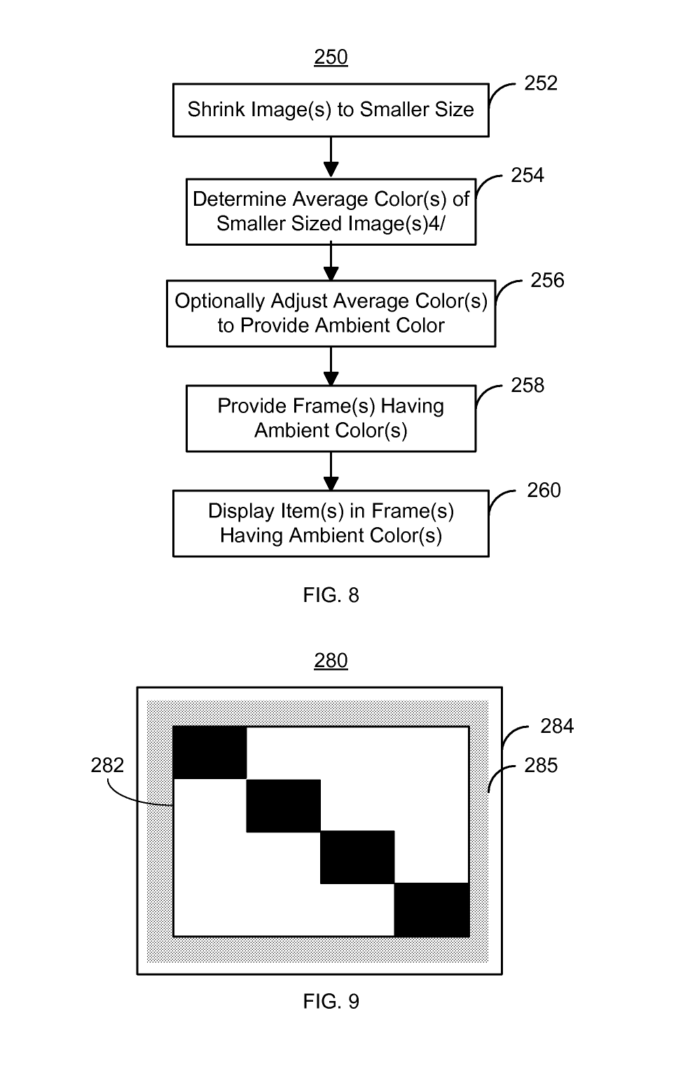

FIG. 8 is a diagram of another exemplary embodiment of a method 250 for displaying content having a frame. The method 250 may be performed in conjunction with the system 100 and/or 120. However, for clarity, the method 250 is described in the context of the system 100. The method 250 may be used to present items, for example images or video, to the user. The method 250 is thus used for items having a plurality of colors, which may include multiple shades. The method 250 is thus used for items having a plurality of colors, which may include multiple shades. In addition, the method 250 is described in the context of providing tasks relating to multiple items simultaneously. However, one of ordinary skill in the art will recognize that the steps may be performed serially, for example to process items one-by-one.

The items to be framed are shrunk to a smaller size, via step 252. In one embodiment, the items are shrunk to a single pixel in step 252. Average, or mean, colors are determined from the reduced size items, via step 254. In one embodiment, the average color may be determined from histograms of the items. However, alternate methods of determining the average color of the reduced sized items may be used. In an embodiment in which the item is shrunk to a single pixel, then the color of the single pixel may be taken as the average. If the item is video, then the shrinking and average color determining may occur multiple times for a particular loop. The average color for video may, therefore, change at transitions between clips. In yet another embodiment the average color might be determined for each frame and, therefore, change between frames. However, in another embodiment, a single average color might be determined for all video shown in a particular loop.

In one embodiment, the ambient color is the average color determined in step 254. However, in another embodiment, the average colors may optionally be adjusted, via step 256. The adjusted average color would then be the ambient color. As discussed above, adjustments may include lightening, darkening, or tinting the average color.

A frame including the ambient color is determined for each of the items to be displayed in a frame, via step 258. Step 258 may be performed using the ambient color framing subsystem 101. Step 258 may include setting the size of the frame as well as the setting the color for at least part of the frame as the ambient color. The items may be displayed in the corresponding frames, via step 260. Step 260 may be performed using the rendering subsystem 105. Because, as discussed above, the ambient color of a video might change, the color of the frame may also change while the item is displayed.

FIG. 9 depicts an exemplary embodiment of a framed item 280 of multimedia content. The item 282 has been framed using the method 200, 210 and/or 250. Although a particular configuration of shapes and colors is depicted in the item 282, a framed item 280 generally has another configuration and may have other colors and/or shapes therein. Because the method 200, 210, and/or 250 is used, the frame 284 includes the ambient color portion 285. Thus, interest may be added to the item 280 using the frame 294. The framed item 280 may be part of a cloud formed using the method 150 and/or 170. Thus, multiple framed items 280 may be shown together.

Thus, using the methods 150, 170, 200, 210, and/or 250 and/or the system 100 and 120, multimedia content may be displayed to users in a configuration that may be more interesting.

A method and system for displaying multimedia content has been disclosed. The present invention has been described in accordance with the embodiments shown, and one of ordinary skill in the art will readily recognize that there could be variations to the embodiments, and any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

We claim:

1. A computer-implemented method for displaying multimedia content including a plurality of items, the method comprising:
determining at least one attribute associated with each of the plurality of items;
determining at least one of a size and a location of each of at least a first portion of the plurality of items based on the at least one attribute, the size and location of one of the at least the first portion of the plurality of items being different from the size and location of another of the at least the first portion of the plurality of items; and
displaying at least a second portion of the plurality of items together in a planar distribution, each of the at least the second portion of plurality of items being displayed in the location and having the size determined using the at least one attribute.

2. The method of claim 1 wherein size and location determining further includes:
determining the size and the location based on the at last one attributes.

3. The method of claim 1 wherein the displaying further includes:
displaying the at least the second portion of plurality of items such that the plurality of items are contiguous.

4. The method of claim 1 wherein the at least one attribute indicates a popularity of each of the plurality of items.

5. The method of claim 4 wherein the at least one attribute includes at least one of a first number of positive comments, a second number of votes, a time viewed, a third number of times viewed, a fourth number of times shared.

6. The method of claim 1 wherein the plurality of items includes a plurality of images.

7. The method of claim 1 wherein the plurality of items includes a plurality of visual tags.

8. The method of claim 1 wherein the first portion and the second portion are the same.

9. A computer-implemented method for displaying multimedia content including a plurality of images, the method comprising:
determining at least one attribute associated with each of the plurality of images, the at least one attribute corresponding to a popularity of each of the plurality of images;
determining a size and a location of each of a first portion of the plurality of images based on the at least one attribute, the size and location of one of the first portion of the plurality of images being different images the size and location of another of the first portion of the plurality of images; and
displaying at least a second portion of the plurality of items together in a contiguous planar distribution, each of the at least the second portion of plurality of items being displayed in the location and having the size determined using the at least one attribute.

10. A computer-implemented method for displaying multimedia content including a plurality of items, the method comprising:
determining an ambient color of an item of the plurality of items, the item having a plurality of colors, the ambient color being based on the plurality of colors;
determining a frame including the ambient color; and
displaying the item in the frame.

11. The method of claim 10 further comprising:
repeating the ambient color determining, frame determining, and item displaying steps for a remaining portion of the plurality of items.

12. The method of claim 10 wherein the ambient color determining further includes:
determining an average color of the item; and
adjusting the average color to provide the ambient color.

13. The method of claim 12 wherein the adjusting further includes:
at least one of lightening the average color a particular amount, darkening the color a particular amount, and adjusting the average color to account for at least one of a display preference.

14. The method of claim 10 wherein the item includes a plurality of colors and wherein the ambient color determining further includes:
providing a histogram of the plurality of colors; and
determining an average of the plurality of colors based on the histogram, the ambient color being based on the average.

15. The method of claim 14 wherein the ambient color determining further includes:
adjusting the average color to provide the ambient color.

16. The method of claim 10 wherein the item has a first size and wherein the ambient color determining further includes:
resizing the item to a second size smaller than the first size; and
determining a color of the second size, the ambient color being based on the color.

17. The method of claim 16 wherein the second size includes a single pixel.

18. The method of claim 16 wherein the ambient color determining further includes:
adjusting the color to provide the ambient color.

19. A computer-implemented method for displaying multimedia content including a plurality of items, the method comprising:
determining an average color of an item of the plurality of items, the item having a plurality of colors, the average color determining including at least one of determining the average color based on a histogram of the plurality of colors and determining the average color based on resizing the item to a single pixel, the single pixel having the average color;
optionally adjusting the average color;
determining a frame including the ambient color, the ambient color being the average color; and
displaying the item in the frame.

20. A computer-readable medium including a program for displaying multimedia content including a plurality of items, the program including instructions for:
determining at least one attribute associated with each of the plurality of items;
determining at least one of a size and a location of each of a first portion of the plurality of items based on the at least one attribute, the size and location of one of the first portion of the plurality of items being different from the size and location of another of the first portion of the plurality of items; and
displaying at least a second portion of the plurality of items together in a planar distribution, each of the at least the second portion of plurality of items being displayed in the location and having the size determined using the at least one attribute.

21. A computer-readable medium including a program for displaying multimedia content including a plurality of items, the program including instructions for:
determining an ambient color of an item of the plurality of items, the item having a plurality of colors, the ambient color being based on the plurality of colors;
determining a frame including the ambient color; and
displaying the item in the frame.

22. A system for displaying multimedia content including a plurality of items, the system comprising:
a display subsystem for a determining at least one attribute associated with each of the plurality of items, determining at least one of a size and a location for each of a first portion of the plurality of items based on the at least one attribute, the size and location of one of the first portion of the plurality of items being different from the size and location of another of the first portion of the plurality of items; and
a display subsystem for displaying at least a second portion of the plurality of items together in a planar distribution, each of the at least the second portion of plurality of items being displayed in the location and having the size determined using the at least one attribute.

23. A system for displaying multimedia content including a plurality of items, the system comprising:
an ambient color subsystem for determining an ambient color of an item of the plurality of items and for determining a frame including the ambient color, the item having a plurality of colors, the ambient color being based on the plurality of colors;
a display system for displaying the item in the frame.
